(19) United States
(12) Patent Application Publication
(10) Pub. No.: US 2024/0152910 A1
(43) Pub. Date: May 9, 2024

(54) SYSTEMS AND METHODS FOR USE IN TOKEN MANAGEMENT

(71) Applicant: MASTERCARD INTERNATIONAL INCORPORATED, Purchase, NY (US)

(72) Inventors: Soumyajit Mitra, New York, NY (US); Issidor L. Iliev, White Plains, NY (US); Martin Etheridge, Woodford Green (GB); Oskar Duris, Walnut Creek, CA (US); Rajasekaran Dhamodharan, San Carlos, CA (US); Rashi Goyal, Plainsboro, NJ (US)

(21) Appl. No.: 18/387,437

(22) Filed: Nov. 6, 2023

Related U.S. Application Data
(60) Provisional application No. 63/423,742, filed on Nov. 8, 2022.

(51) Int. Cl. G06Q 20/36; G06Q 20/08

(52) U.S. Cl. CPC G06Q 20/3676; G06Q 20/0855

(57) ABSTRACT

Systems and methods are provided for use in token management. One example computer-implemented method includes receiving, from a first user, a request to redeem a first token having a first value, where the first token is issued by a consortium of multiple parties. In response to the request, the method includes identifying, based on one or more criteria, one of the multiple parties to settle a redemption of the first token. And, the method then includes initiating transfer of the first value from the one of the multiple parties to an account specific to the first user.

### CROSS-REFERENCE TO RELATED APPLICATION

This application claims the benefit of, and priority to, U.S. Provisional Application No. 63/423,742, filed Nov. 8, 2022. The entire disclosure of the above application is incorporated herein by reference.

### FIELD

The present disclosure generally relates to systems and methods for use in managing token exchanges among participants.

### BACKGROUND

This section provides background information related to the present disclosure which is not necessarily prior art.

It is known for parties to rely on different types of ledgers to manage interactions. For example, blockchain ledgers are known to be used to manage the exchange of cryptocurrencies between parties. The entries in the blockchain ledger are immutable to provide evidence of chain of ownership of the cryptocurrencies.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in managing tokens;

FIG. 2 is a block diagram of an example computing device that may be used in the system of FIG. 1;

FIG. 3 is a flow diagram of an example method, which may be implemented in connection with the system of FIG. 1, for use in token management; and

FIGS. 4-5 include additional exemplary flows for use in managing tokens, and which may be implemented in connection with the system of FIG. 1 and/or the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Users may exchange monetary value in a variety of different forms. The security and accessibility of cash, liabilities, cryptocurrencies, etc. permit users to select a monetary form specific to a transaction. Fiat moneys, for example, may be exchanged, as bearer moneys, or may be converted to tokens. The exchange of tokens conventionally, however, is associated with security, acceptance, accessibility, and/or convenience issues, etc.

Uniquely, the systems and methods herein provide for exchange of tokens, which are backed by fiat moneys, through single token or multi-token schemes, etc. In particular, specific tokens are minted, through an immutable ledger, for example, and backed by fiat moneys, either by a party (or group of parties) or a token host, whereby the tokens are then acceptable to be exchanged among users associated with the parties as a form of monetary transfer (e.g., transfer 10 USDM-A, in lieu of transferring $10 USD, etc.). The tokens may be exchanged directly or for other tokens, whereby acceptance, accessibility, and/or convenience of the tokens is extended.

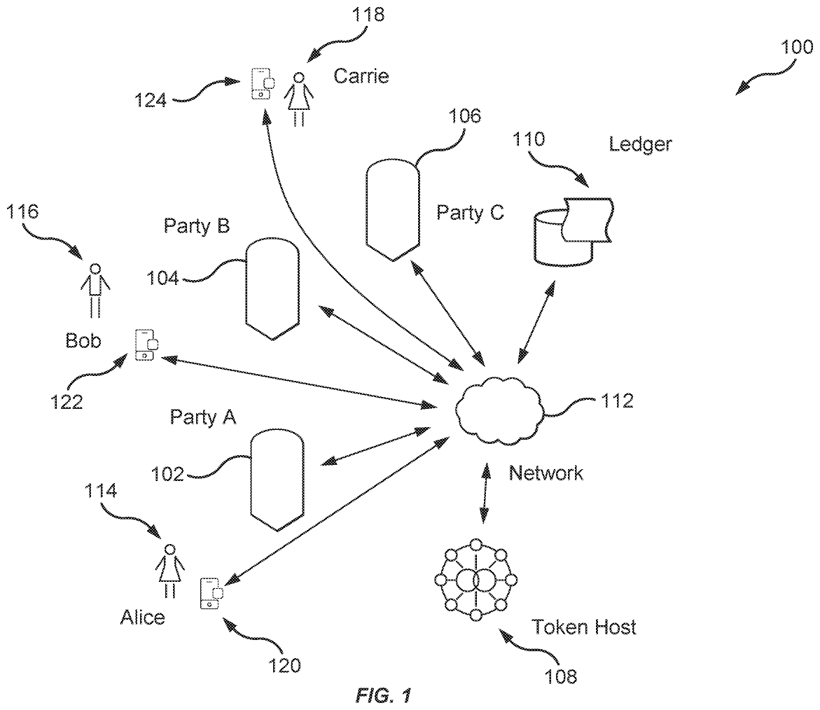

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, types of tokens, parties, privacy regulations and/or requirements, etc.

The system 100 generally includes parties 102, 104, and 106, a token host 108, and a ledger 110, each coupled to (and in communication with) network 112. The network 112 may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The parties 102, 104, 106 are each generally a financial institution, such as, for example, a bank, etc. More generally, the parties 102, 104, 106 are configured to issue accounts to users 114, 116, and 118, respectively, which may include financial accounts (e.g., checking accounts, savings accounts, credit accounts, etc.), whereby fiat moneys are held by the respective party on behalf of the corresponding user (to whom an account is issued by the party). The user may then coordinate with the respective party to transfer the fiat moneys to another user (or users), or to another party (or parties) for one or more reasons. While the accounts issued by the parties 102, 104, 106, in this example, include fiat moneys, or government-issued moneys, it should be appreciated that other monetary forms may be included in the accounts as well.

In this example embodiment, the party 102 is also referenced herein as Bank A (or Party A), and is configured to issue an account to the user 114, i.e., Alice; the party 104 is also referenced to herein as Bank B (or Party B), and is configured to issue an account to the user 116, i.e., Bob; and the party 106 is also referenced herein as Bank C (or Party C), and is configured to issue an account to the user 118, i.e., Carrie. Each of the accounts is associated with and/or contains an amount of fiat money (e.g., $100 USD, etc.). As further shown in FIG. 1, each of Alice, Bob and Carrie are associated with a communication device 120, 122, 124, respectively. The communication devices may each include a mobile device, such as, for example, a smartphone, a tablet, etc., which is configured to communicate with other devices/parts of FIG. 1, via the network 112. In this example embodiment, each of the communication devices 120, 122, 124 include a wallet application or other suitable program, or web browser, which configures the communication device to perform as described herein. In particular, for example, the communication devices 120, 122, 124 are each configured to communicate with the ledger 110, to determine a balance of one or more different types of tokens associated with or held by the respective users, Alice, Bob, and Carrie, etc. For example the communication device 120 is configured, by the wallet application included therein, to retrieve, from the ledger 110, a balance of USDM-A, USDM-B and/or USDM-C held by Alice, as reflected in the respective smart contracts on the ledger 110, etc.

In the system 100, each of the parties 102, 104, 106 and the token host 108 is configured to mint tokens in connection with the ledger 110. That is, the party 102, for example, is configured to request a number of tokens be minted to a specific user, whereby the ledger 110 is configured to generate the token(s), specific to the party 102 (e.g., specific to a smart contract of the party 102, etc.), to assign the token to the specific user, and to confirm the same to the party 102. Each token is generally a piece of data, or string of data, which is generated based on one or more techniques (e.g., via a key, a secret, etc.). The token is unique, generally, yet consistent with one or more forms, standards or formats, and may include or not an indicator of the party that minted/generated the token. For example, the token may be fungible, whereby a USDM-A token is generally indistinguishable from another USDM-A token, once minted or issued. The ledger 110 is configured to generate and to record the token in a data structure, such as, for example, a blockchain or other immutable data structure, etc., along with data related to the party minting the token and the holder of the token (e.g., as part of a smart contract, etc.).

Given the above, there are a number of different implementations of tokens in the system 100, which are described herein, whereby the tokens, or multiple tokens, may be exchanged in lieu of fiat moneys.

In a first example implementation, each of the parties 102, 104, 106 is configured to mint tokens specific to the respective party. Each party is configured to create a smart contract and to record the smart contract to the ledger 110, whereby the party is permitted to mint tokens specific to its own smart contract. That is, for example, Bank A (e.g., party 102) is configured to mint tokens, USDM-A; Bank B (e.g., party 104) is configured to mint tokens, USDM-B; and Bank C (e.g., party 106) is configured to mint tokens, USDM-C.

In particular in this example, Bank A includes an account specific to Alice, which includes $100 USD. When Alice requests to convert $20 USD to $20 in tokens, USDM-A, Bank A is configured to mint $20 worth of USDM-A (e.g., pursuant to a smart contract at the ledger 110, etc.), and to create an entry in the ledger 110 for the USDM-A indicative of the transfer, and then to read from the ledger 110 and reflect the 20 of USDM-A in the wallet application in the communication device 120 (associated with Alice). The entry in the ledger 110 includes the token USDM-A, the amount, and the holder, i.e., Alice. It should be appreciated that, in this example, the token(s), i.e., USDM-A, are specific to Bank A and the tokens include an identifier of Bank A. In addition, Bank A is configured to debit the $20 USD from the account of Alice. Consequently, Alice's account with Bank A includes $80 USD and 20 USDM-A, and the $20 is moved to an account of Bank A underlying the minting of USDM-A tokens. It should be understood that the USDM-A may be one or multiple tokens in the same of different denominations. In this exemplary embodiment, each USDM-A token may be equivalent to $1 USD. It should be appreciated that other tokens in other embodiments may include different denominations,

Alice is then permitted to transfer 5 USDM-A to Bob, for example, whereby the wallet application configures the communication device 120 to initiate a transfer transaction (e.g., in the amount of $5 USD), which causes the 5 USDM-A to be populated into the wallet application of communication device 122 of Bob. An entry is generated by the wallet application (or host associated with the wallet application (e.g., the token host 108, etc.) and/or or the ledger 110, where the entry is indicative of the transfer of the token(s) from Alice to Bob. In this manner, Alice retains 15 USDM-A and Bob has 5 USDM-A. It should be noted here that Bob has an account issued by Bank B, but the 5 USDM-A is associated with and/or minted by the Bank A.

Consistent therewith, for Bob to redeem the USDM-A, the Bank B is configured to initiate a transfer, via a payment processing network (e.g., the MASTERCARD network, etc.) (e.g., via conventional ISO 8583 standard messaging, or ISO20022 standard messaging, etc.), with the Bank A. The payment processing network is configured to identify Bank A from the USDM-A, to verify the token(s)/transaction for potential fraud, risks, etc., and to transmit the redemption request including the USDM-A to Bank A, whereupon Bank A may be configured to verify the token, transfer, etc. Once verified (e.g., based on various techniques (e.g., key validation, verifying against ledger 110, etc.), etc.), Bank A is configured to acknowledge the redemption, whereby an account number for the USDM-A account is provided, along with one or more other identifiers specific to the redemption, for example. In response, Bank B is configured to create an entry in a clearing file associated with the payment processing network (e.g., between the USDM-A account and Bob's account, etc.) and to post an entry to the ledger 110, which “burns” or eliminated the redeemed tokens. In connection therewith, Bank A is configured to include a debit of the USDM-A account for the redeemed value, and to include the redemption in a clearing file. Banks A and B are configured to submit their respective clearing files, and as part of the settlement, the processing network is configured to transfer the funds from Bank A to Bank B, and specifically, Bob's account at Bank B.

It should be appreciated that various different token transfers may be completed consistent with the above. It should also be appreciated that the other parties may also mint tokens specific thereto, including, for example, USDM-B tokens specific to Bank B and USDM-C tokens specific to Bank C, whereby the tokens are reflected in the wallet applications of the respective users and transferred, as explained above.

Further, it should be appreciated that the tokens minted by the different parties 102, 104, 106 may be associated with and/or recorded at one or more different smart contracts (broadly, data structures with programmability) of the ledger 110 or of different ledgers (e.g., USDM-A may be recorded in ledger 110, while USDM-B may be recorded in a different ledger; etc.). In such embodiments, the smart contract by which the tokens are minted may be recorded at the different ledgers, and potentially, the tokens may be indicative of not only the minting bank, but also the specific ledger, and a smart contract at that ledger by which the token was minted.

In a second implementation, each of the parties 102, 104, 106 is a participant in a consortium, or other relationship, by agreement of the participants/parties. In this example, a single smart contract is created (e.g., based on terms specific to the consortium, or otherwise; etc.), and recorded to the ledger 110. Each of the parties 102, 104, 106 is then configured to mint USDM, through the same smart contract. That is, USDM is agnostic to all of the banks/parties of the consortium (and generally indistinguishable to the bank that minted the token).

In particular, Bank A includes an account specific to Alice, which includes $100 USD. When Alice requests to convert $20 USD to $20 in tokens of USDM, Bank A is configured to mint 20 USDM (e.g., pursuant to the smart contract at the ledger 110, etc.), to create an entry on the ledger 110, which includes the token USDM and the holder, i.e., Alice., and to reflect the 20 USDM in the wallet application in the communication device 120 associated with Alice, based on a read from the ledger 110. In addition, Bank A is configured to debit the $20 USD from the account of Alice, and may deposit the $20 USD in a common account associated with the USDM at Bank A or elsewhere. As described, it should again be appreciated that, in this example, the token(s), i.e., USDM, is/are not generally specific to Bank A.

Additionally in this example, or alternatively, Bank A may be configured to mint 1000 USDM or some other amount of general USDM, which is funded by funds of Bank A, whereby the USDM are included to an account specific to Bank A. Then, when Alice requests tokens, Bank A is configured to transfer the already minted USDM from its account to Alice (and specifically, Alice's wallet application) in the appropriate amount, and then to debit Alice's account for the fiat moneys associated with the tokens. Bank A is configured to also indicate the transfer to Alice through an entry in the ledger 110.

Bank B and Bank C may be configured to perform similarly to mint tokens (USDM), via the ledger 110, for Bob and Carrie.

Also, consistent with the above, the users, Alice, Bob and Carrie, may transfer token therebetween. For example, Alice and Bob may each transfer 5 USDM to Carrie, for example, whereby the 5 USDM is moved in the smart contract on the ledger 110, whereby the balances of each of Alice, Bob, and Carrie is updated, and then reflected in the wallet applications of communication devices 120 and 122 and also the wallet application of communication device 124 of Carrie. That is, the smart contract in the ledger 110 is configured to register the balance for all token holders. As such, for the transfer from Alice and Bob to Carrie, the ledger 110 is configured to update the registry of the smart contract to include the debit (from Alice and Bob) and credit (to Carrie). The wallet applications are configured to read the registry in the ledger 110 and to reflect the balances to the respective users. Entries are generated by the wallet applications (or host associated with the wallet application (e.g., the token host 108, etc.)) and/or or the ledger 110, where the entry is indicative of the transfer from Alice (i.e., send 5 USDM) and Bob (i.e., send 5 USDM) to Carrie (i.e., receive 10 USDM).

In connection with redemption, multiple options may be implemented as part of different embodiments. In one redemption example, as indicated above, when the USDM is minted by the parties 102, 104, 106, each is configured to contribute an amount equal to the minted USDM to a collateral fund, which is central to the consortium. The collateral account may be issued by any of the illustrated banks in FIG. 1, another bank, or potentially, the token host 108, etc. In this example, each of Bank A, Bank B and Bank C contributed, and the amount included in the collateral account is equal to all USDM minted under the specific smart contract. As part of redemption, then, Bank C, for example, in connection with Carrie redeeming the 10 USDM, is configured to initiate a transaction between the collateral account and Carrie's account. The transaction is coordinated through the payment processing network, as required, whereby clearing files and settlement includes the transaction (i.e., debit of the collateral account and credit to Carrie's account), and Bank C is configured to include an entry in ledger 110 to represent the burn of the 10 USDM upon redemption.

In another redemption example, the consortium is configured to define redemption criteria, whereby the tokens are redeemed consistent therewith. In connection with minting of tokens, the token host 108, for example, is configured to track a number of tokens minted by the different parties 102, 104, 106, and also the number of tokens redeemed for the same parties. The token host 108 is configured to coordinate redemption based on the tracked numbers.

In particular, as part of this example, Bank A is configured to mint 100 USDM, and to transfer 20 USDM to Alice, while Bank B is configured to mint 200 USDM, and to transfer 5 USDM to Bob and Bank C is configured to mint 1000 USDM, and to transfer 30 USDM to Carrie. Each of the banks may be configured to deposit funds consistent with the minted tokens into an account, or potentially, identify the liability in another manner, etc. Subsequently, consistent with the above, Carrie transfers 12 USDM to Bob, whereby Bank C or Bank B (or associated wallet application or host) is configured to include an entry in the ledger 110 indicative of the transfer. Bob may then seek to redeem 17 USDM at Bank B.

In turn, Bank B is configured to submit the redemption request to the token host 108.

The token host 108 is configured to determine which bank or combination of banks are to fund the redemption, based on the defined criteria. Such criteria may include, for example, last in-first out (LIFO), first in-first out (FIFO), earliest issued, percentage-based (e.g., redemption based on 100/200/1000 ratio between the different banks above, etc.), max outstanding threshold, same jurisdiction, etc. In this example, the token host identifies Bank C as the redemption bank, based on one or more of the criteria above. As such, the token host 108 is configured to initiate a transfer between Bank C and Bob's account at Bank B via the payment processing network (e.g., the MASTERCARD network, etc.) (e.g., via conventional ISO 8583 standard messaging, or ISO2022 standard messaging, etc.). Consistent with the above, Bank C is configured to include a debit entry in a clearing file associated with the payment processing network (e.g., between Bank C's account backing the previously issued tokens and Bob's account, etc.). Similarly, Bank B is configured to include a credit entry for Bob's account in its clearing file. Banks B and C are configured to submit their respective clearing files, and as part of the settlement, the processing network is configured to transfer the funds from Bank C to Bank B, and specifically, Bob's account at Bank B. The token host 108, or potentially, Bank C, is configured to post an entry to the ledger 110, which burns or redeems the associated 17 USDM.

In yet another redemption example, the tokens are issued, generally, as USDM via a consortium of the parties 102, 104, 106, where the USDM is not linked back to the issuing bank of the users, Alice, Bob or Carrie, yet is backed by tokens specific to the banks.

In particular, Bank A is configured to mint USDM-A under a first smart contract (on the ledger 110), and to deposit funds into an account, at Bank A, which is associated with the minted tokens. In this exemplary embodiment, the tokens, USDM-A, are specific to Bank A and therefore are transferable to users of Bank A (and may or may not be transferred to users associated with other banks, i.e., Banks B and C). The token host 108 is also configured to mint tokens, i.e., USDM, which are not backed by fiat moneys directly, but are backed by other tokens. Accordingly, when Alice wishes to transfer 10 USDM-A to Bob, Alice requests USDM from Bank A or token host 108. In turn, Bank A and/or the token host 108 is configured to transfer 10 USDM-A, from Alice's wallet application (or more generally, account) to a pool associated with the USDM, through an entry in the ledger 110. The Bank A and/or the token host 108 is configured to mint 10 USDM and/or to transfer 10 USDM to Alice's account, which is reflected in another entry at the ledger 110. Alice is then permitted to transfer the 10 USDM to Bob, and Bob is permitted to exchange the USDM for tokens specific to Bank B, i.e., USDM-B, so that Bob is able to redeem the tokens at his bank, Bank B.

It should be appreciated that the token host 108 may be configured to impose criteria for participation in the pool, by the banks, whereby USDM-A, USDM-B and USDM-C tokens may be burned to mint other tokens depending on the demand for the particular tokens in the pool. The token host 108, in connection therewith, would be configured to burn the tokens consistent with the description above, whereby a fund transfer from Bank A to the token host 108 (e.g., via the payment processing network, etc.) accompanies the burn of the USDM-A, and a second transfer of those funds from the token host 108 to Bank B accompanies the minting the USDM-B, etc. It should be understood that various different criteria may be selected and/or imposed to direct balancing of different tokens in the pool, generally or based on specific user demands, etc.

In a third implementation, the parties 102, 104, 106 and the token host 108 are configured to mint tokens specific thereto. As such, Bank A is configured to mint tokens, USDM-A; Bank B is configured to mint tokens, USDM-B; and Bank C is configured to mint tokens, USDM-C. And, also, token host 108 is configured to mint tokens USDM-H. In this embodiment, the token host 110 is configured to maintain an account at Bank A, Bank B and Bank C. Consequently, the token host 108 is configured to purchase tokens from the respective banks, whereby, for example, Bank A is configured to mint 500 USDM-A for the token host 108 and to debit $500 from the account of the token host 108. As above, the USDM-A are included on the ledger 110 under the smart contract for Bank A. The token host 108 is configured to request the same from Bank B and Bank C, whereby the token host 108 is configured to maintain a pool of tokens from the participants, i.e., the parties 102, 104, 106.

In addition, the token host 108 is configured to also mint tokens USDM-H, under a smart contract specific to the token host 108, in response to requests from one or more users. In some examples, the tokens may be “NAME” coins, which are used by others, through the token host 108, for example, as a universal token. In one example, where Alice requests a conversion of 25 USDM-A to 25 USDM-H, Alice transfers the tokens from her account to the pool of the token host 108. The token host 108 is configured to mint the 25 USDM-H, based on the transferred USDM-A, and to transfer the USDM-H to Alice. Each of the transfers is recorded in the ledger 110 under the appropriate smart contract. That is, Bank A's smart contract for the USDM-A, and the token host's smart contract for the USDM-H.

It should be appreciated that the USDM-H is a common token, in this example implementation, which is acceptable for a wide variety of use cases which are native to the ledger 110. That is, different parties, services, merchants, etc., may accept transfers of the USDM-H as payment for goods, services, deposits, debits, etc., whereby transfers are indicated through entries in the ledger 110, whereupon receipt may proceed as described herein to redeem the USDM-H, or further transfer or hold the tokens.

Based on the above, it should be appreciated that Alice may then transfer the USDM-H to Bob or Carrie, etc., for one or more reasons. When Bob receives 10 USDM-H from Alice, in his wallet account, Bob may hold or transfer the USDM-H, as he wishes. If, however, he wishes to redeem the tokens at Bank B, Bob requests the token host 108 to convert the USDM-H to USDM-B (or to USDM-A, for redemption as explained above). It should be appreciated that Bob may additionally or alternatively decide on a common token (for him), whereby Bob may request conversion of tokens to USDM-A, for example, to consolidate tokens to one type and/or smart contract (e.g., to a token already held by the user, a preferred token for transacting, etc.). The specific selected token (e.g., USDM-H, or USDM-A, etc.) may be consistent with the party/bank, with which the user has an account, or not.

When Carrie receives 10 USDM-H from Alice, as reflected in her wallet account, Carrie may hold or transfer the USDM-H, as she wishes. If, however, she wishes to redeem the tokens at Bank C, Carrie requests the token host 108 to convert the USDM-H to USDM-C. In response to the request, the token host 108 is configured to transfer the USDM-C tokens from the token pool to Carrie (e.g., via an entry in Bank C's smart contract on the ledger 110, etc.), and then, to burn the incoming USDM-H (e.g., via an entry in the token host's smart contract on the ledger 110, etc.). If there is insufficient USDM-C in the token pool, the token host 108 is configured to request Bank C to mint additional USDM-C and to debit the token host's account accordingly via the payment processing network (e.g., the MASTERCARD network, etc.) (e.g., via conventional ISO 8583 standard messaging, or ISO2022 standard messaging, etc.). When the USDM-C is added to the token pool, the token host 108 is then configured to satisfy Carrie's request to convert the USDM-H to USDM-C (as indicated in the respective smart contracts on the ledger 110), whereby Carrie could choose to redeem or hold the USDM-C, as explained above.

It should be appreciated that from time to time, the token host 108 may be configured to balance the token pool, through redemption of certain tokens and/or the purchase of other tokens based on one or more criteria, or to redeem certain tokens to maintain a level of assets/liabilities, etc. It should further be appreciated that while Alice transferred USDM-H to Bob, in one or more embodiments Alice may be permitted to transfer USDM-A or USDM-H to Bob, or any other tokens included in Alice's wallet account. In such embodiments, the token host 108 may be configured to provide for conversion between the different tokens as requested, even if not associated with USDM-H, etc.

While only three banks/parties 102-106, three users 114-118, one token host 108 and one ledger 110 are illustrated in FIG. 1, it should be appreciated that any number of banks/parties, users, hosts, ledgers, etc., may be included in other embodiments. What's more, in connection with the implementations described above, it should be appreciated that the different tokens, parties, etc., may be combined in one or more different manners within the scope of the present disclosure to define a further implementation of the concepts described herein.

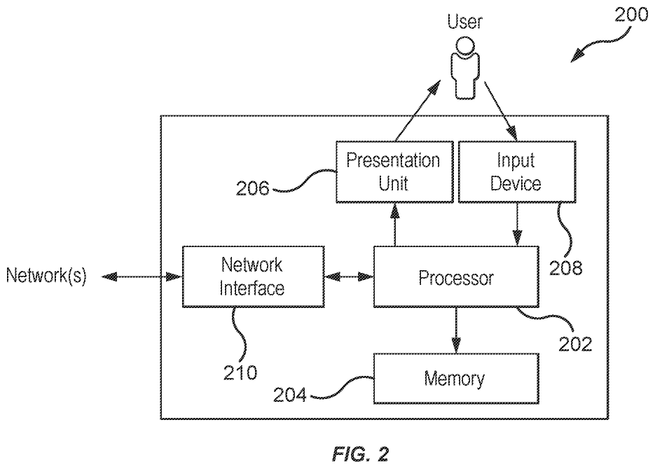

FIG. 2 illustrates an example computing device 200 that can be used in the system 100. The computing device 200 may include, for example, one or more servers, workstations, personal computers, laptops, tablets, smartphones, point-of-sale (POS) terminals, payment devices, etc. In addition, the computing device 200 may include a single computing device, or it may include multiple computing devices located in proximity or distributed over a geographic region, so long as the computing devices are specifically configured to function as described herein. In particular, in the example system 100 of FIG. 1, each of the parties 102, 104, 106, the token host 108 and the ledger 108 may include, or may be implemented in, a computing device, such as the computing device 200. In addition, the communication devices 120, 122, 124 may each be considered a computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

With reference now to FIG. 2, the computing device 200 generally includes a processor 202, and a memory 204 that is coupled to (and in communication with) the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are examples only, and are not intended to limit in any way the definition and/or meaning of processor.

The memory 204, as described herein, is one or more devices that enable information, such as executable instructions and/or other data, to be stored and retrieved. The memory 204 may be configured to store, without limitation, tokens, ledger entries, and/or other types of data suitable for use as described herein, etc. In addition, the memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. It should be appreciated that the memory 204 may include a variety of different memories. In various embodiments, computer-executable instructions may be stored in the memory 204 for execution by the processor 202 to cause the processor 202 to perform one or more of the operations described herein (e.g., one or more of the operations recited in method 300 or otherwise described herein, etc.), such that the memory 204 is a physical, tangible, and non-transitory computer-readable media and such that the instructions stored in the memory 204 enable the computing device to operate as (or transform the computing device into) a specific-purpose device configured to then effect the features described herein.

The computing device 200 also includes a presentation unit 206 and an input device 208 coupled to (and in communication with) the processor 202.

The presentation unit 206 outputs information and/or data to a user (e.g., Alice, Bob, Carrie, etc.) by, for example, displaying, audibilizing, and/or otherwise outputting the information and/or data. In some embodiments, the presentation unit 206 may comprise a display device such that various interfaces (e.g., application screens, webpages, SMS messages, etc.) may be displayed at computing device 200, at the display device, to display such information and/or data, etc. With that said, the presentation unit 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 206 may include multiple devices in some embodiments.

The input device 208, when present in the computing device 200, is configured to receive input from users, including, for example, direction to transfer tokens, or to redeem token, etc. The input device may include, without limitation, a keyboard, a mouse, a touch sensitive panel (e.g., a touch pad or a touch screen, etc.), another computing device, and/or an audio input device. Further, in some example embodiments, a touch screen, such as that included in a tablet, a smartphone, or similar device, may function as both the presentation unit 206 and the input device 208.

The illustrated computing device 200 further includes a network interface 210 coupled to (and in communication with) the processor 202 and the memory 204. The network interface 210 may include, without limitation, a wired network adapter, a wireless network adapter, a mobile adapter, or other device capable of communicating, for example, to network 112 (e.g., the Internet, a private or public LAN, WAN, mobile network, combinations thereof, or other suitable networks, etc.) in the system 100. In some example embodiments, the processor 202 and one or more network interfaces may be incorporated together.

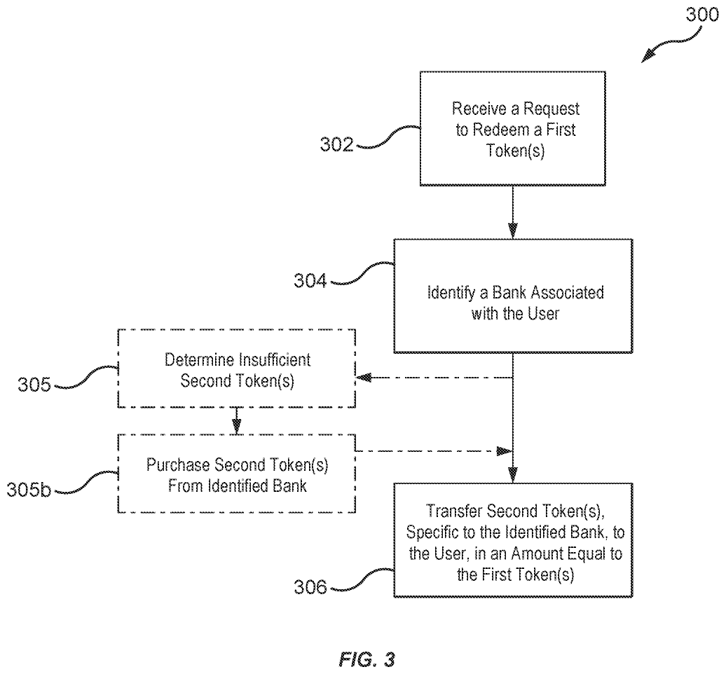

FIG. 3 illustrates an example method 300 for use in token management. The example method 300 is described as implemented in the parts of the system 100. And, reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, a request is received, at 302, from a user, e.g., Alice (e.g., user 114, etc.), (or Bank A (e.g., party 102, etc.) associated with Alice) to redeem a first token, at the token host 108. In this example, the first token includes a common token, or universal token, USDM-H. The request may be received, at the token host 108, via the wallet application in the communication device 118.

In response, at 304, the token host 108 identifies the bank associated with the user. For instance, given that the first token is a USDM-H, which is specific to the token host 108, the token host 108 identifies the bank associated with the user (e.g., Alice in this example, etc.), which in this example is Bank A. The bank may be identified based on data associated with the user, or content of the request to redeem the first token. In at least one example embodiment, Alice may specifically indicate Bank A.

At 306, the token host 108 transfers the second token, or USDM-A, in this example, to Alice through with the ledger 110. In doing so, the ledger 110 records an entry, and specifically, to a contract specific to the USDM-A, indicating the transfer of a number of USDM-A (generally consistent with a number of USDM-H to be redeemed) to Alice. In connection therewith, Alice (or the wallet application or a host associated with the wallet application (e.g., Bank A, etc.)), causes an entry to the included in the ledger 110, and specifically, a contract specific to the USDM-H, indicating the transfer of the USDM-H to the token host 108 and/or the burning of the USDM-H.

As shown in FIG. 3, the token host 108 may, optionally, as indicated by the dashed lines, determine, at 305a, whether the token host 108 has sufficient USDM-A to satisfy the redemption request. When there are insufficient second tokens, i.e., USDM-A, in this example, the token host 108 purchases, at 305b, the second tokens from the identified bank, or in this example, Bank A, for example, via the payment processing network (e.g., the MASTERCARD network, etc.) (e.g., via conventional ISO 8583 standard messaging, or ISO2022 standard messaging, etc.). Thereafter, the token host 108 transfers, at 306, as indicated above, through an entry at the ledger 110, the USDM-A to Alice, whereupon the USDM-H is transferred, through an entry at the ledger 110, to the token host 108 and/or burned.

While FIG. 3 is described with reference to the token host 108, it should be appreciated that one or more of the steps included in method 300 may be performed in whole or in part by the parties 102, 104, and/or 106, in different embodiments of token management.

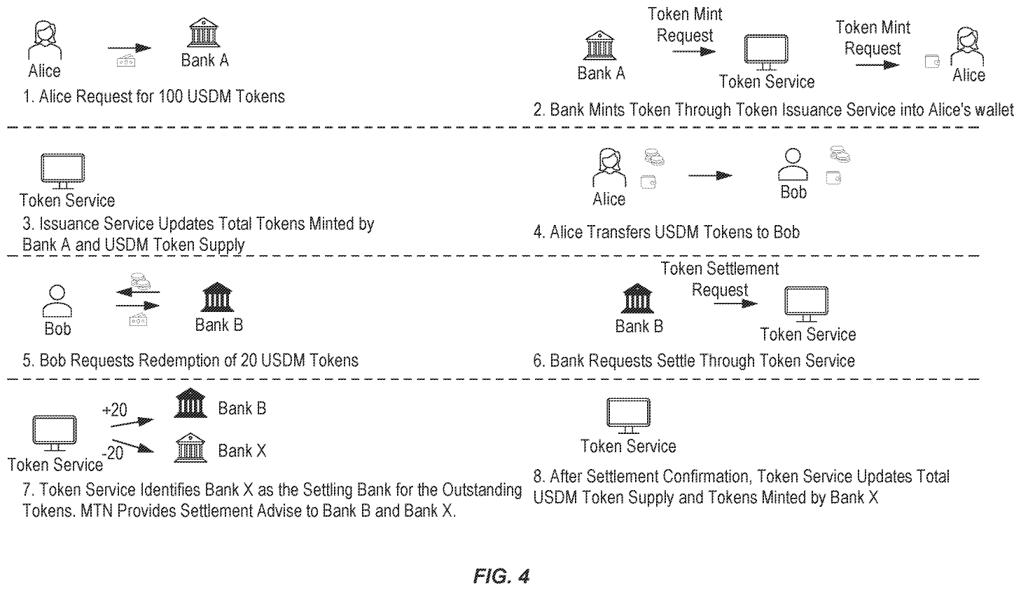

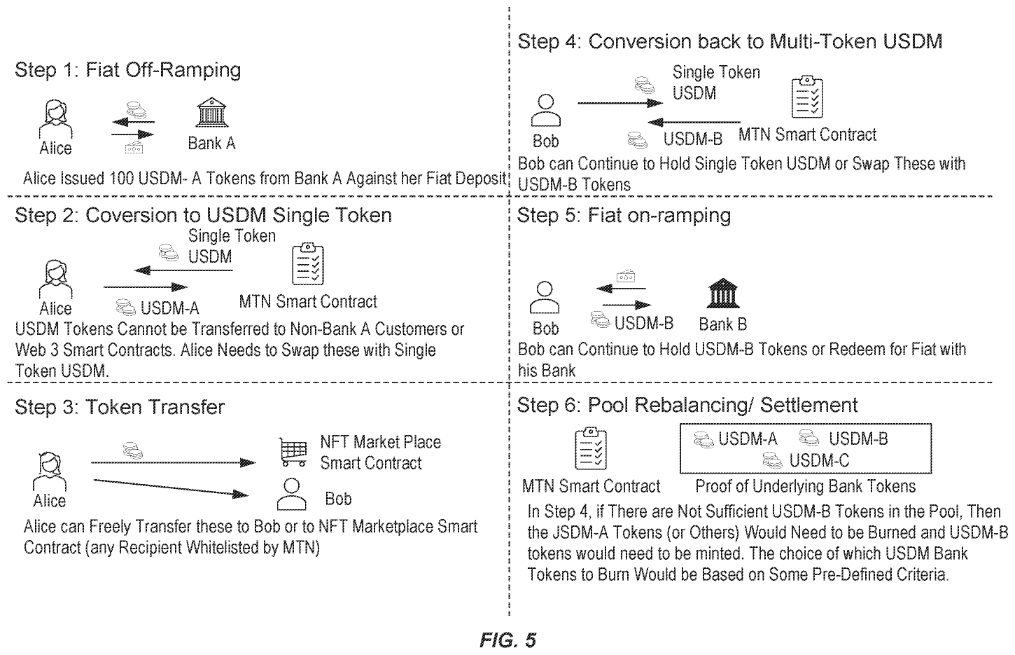

FIGS. 4-5 illustrate additional example flows/methods, which may be implemented by and through the parts of the system 100. However, the example flows herein should not be understood to be limited to the system 100 or the computing device 200, as the example flows/methods may be implemented in other systems and/or computing devices within the scope of the present disclosure. Likewise, the systems and the computing devices herein should not be understood to be limited to the example flows/methods shown in FIGS. 4-5.

In the example flow shown in FIG. 4, a party, e.g. Bank A, has issued an account specific to a user 114, e.g. Alice, which includes $100 USD. Alice wishes to convert the $100 USD into 100 USDM (e.g., at step 1). In response to a request from Alice, Bank A mints the tokens, i.e., the USDM, through a token issuance service (e.g., the token host 108, etc.), whereby the money is debited from Alice's account, and Alice is issued 100 USDM (e.g., where each USDM is $1 USD, etc.) (e.g., at step 2). The token issuance service then updates the token tokens minted by Bank A and the USDM supply (e.g., in the ledger 110, etc.) (e.g., at step 3).

Next, Alice transfers some or all of the USDM, from her wallet, to another user, for example, user 116, e.g. Bob (e.g., at step 4).

In turn, at some time later, Bob request to redeem the USDM with a party, e.g., Bank B, which issued an account to Bob, for fiat moneys (e.g., $20 USD, etc.) (e.g., at step 5). In response, Bank B requests settlement through the conversion token issuance service (e.g., the token host 108, etc.) (e.g., at step 6). The token host 108 requests settlement with another party, e.g., Bank X, which is the settling bank for the specific USDM (e.g., a step 7). A transaction is initiated, by the token host 108, between Bank A and Bank X for the fiat money equivalent to the USDM to be redeemed, for example, through settlement advisements to each of the banks (e.g., via the payment processing network, etc.). When the transaction is settled between the banks, the token host 108 updates the ledger 110 to reflect the redemption of the USDM and remaining counts of the supply of USDM minted by Bank X (e.g., at step 8).

In the example flow shown in FIG. 5, a party, e.g., Bank A, issues an account specific to Alice (broadly, a user 114), which includes $100 USD. In response to a request from Alice for 100 USDM-A, Bank A mints the 100 USDM-A (e.g., pursuant to a smart contract at the ledger 110, etc.) and issues the same to Alice (e.g., at step 1). In doing so, an entry is created in the ledger 110 for the USDM-A indicative of the transfer, and the transfer is reflected in the wallet application in the communication device 120 (associated with Alice). The entry in the ledger 110 includes the type (or issuer) of the token, i.e., USDM-A, the number of tokens, and the holder, i.e., Alice. In addition, Bank A debits $100 USD from the account of Alice. Consequently, Alice is now in possession of 100 USDM-A. In this example, for simplicity, each USDM-A token may be equivalent to $1 USD.

Subsequently, Alice may decide to transfer 5 USDM-A to Bob. Because Bob is not a customer or account holder with Bank A, the USDM-A cannot be transferred directly to Bob. As such, in this example, Alice requests a conversion of 5 USDM-A to 5 USDM-H (e.g., at step 2). Alice transfers the tokens from her account to the token host 108. The token host 108 is configured to mint the 5 USDM-H, based on the transferred USDM-A, and to transfer the USDM-H to Alice. Each of the transfers is recorded in the ledger 110 under the appropriate smart contract. That is, Bank A's smart contract for the USDM-A, and the token host's smart contract for the USDM-H.

It should be appreciated that, as above, the USDM-H is a common token, in this example implementation, which is acceptable for a wide variety of use cases which are native to the ledger 110.

Alice is then able to transfer the USDM-H to Bob (e.g., at step 3). When Bob receives the 5 USDM-H from Alice, in his wallet account, Bob may hold or transfer the USDM-H. As shown (e.g., at step 4), Bob may request the token host 108 to convert the USDM-H to USDM-B, i.e., tokens associated with Bank B, which has issued an account to Bob. Bob may then hold the USDM-B in his wallet, as shown (e.g., at step 5), or redeem the USDM-B for fiat moneys with Bank B, whereby the fiat moneys are credited to Bob's account.

It should be appreciated that the token host 108 may interact with Bank A, Bank B and other banks to service tokens minted thereby, whereby rules may be imposed to burn tokens, mint tokens, etc., to satisfy the request of the customers using the specific tokens (e.g., as shown in step 6).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing: (a) receiving, from a first user, a request to redeem a first token having a first value, the first token issued by a consortium of multiple parties; (b) in response to the request, identifying, by a computing device of a token host computing, based on one or more criteria, one of the multiple parties to settle a redemption of the first token; (c) initiating, by the computing device, transfer of a second token, specific to the one of the multiple parties, to an account of the first user, in exchange for the first token; or (d) receiving, from a first user, a request to redeem a first token having a first value, the first token issued by a consortium of multiple parties; (e) in response to the request, identifying, based on one or more criteria, one of the multiple parties to settle a redemption of the first token; and (f) initiating transfer of the first value from the one of the multiple parties to an account specific to the first user; or (g) converting the first token to a second token, the second token minted by the one of the multiple parties; or (h) in response to a request to redeem a number of common tokens, for a user: (i) burning, by a computing device of a token host, the number of common tokens on a ledger, as indicated in a first entry at the ledger; and (ii) transferring, by the computing device, a number of first tokens, which is equal to the number of common tokens, to the user, as indicated at a second entry at the ledger, the first tokens being minted, at the ledger, by a party, which issued an account of the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in token management, the method comprising:
receiving, from a first user, a request to redeem a first token having a first value, the first token issued by a consortium of multiple parties;
in response to the request, identifying, by a computing device of a token host, based on one or more criteria, one of the multiple parties to settle a redemption of the first token; and
initiating, by the computing device, transfer of a second token, specific to the one of the multiple parties, to an account of the first user, in exchange for the first token.

2. The computer-implemented method of claim 1, further comprising recording, by the computing device, to a ledger associated with the first token, an entry indicative of the redemption of the first token.

3. The computer-implemented method of claim 1, wherein the first token includes multiple first tokens having the first value and the second token included multiple second tokens; and
wherein the multiple second tokens have a second value; and
wherein the first value of the multiple first tokens is equal to the second value.

4. The computer-implemented method of claim 1, further comprising:
determining, by the computing device, whether the token host includes the second token; and
purchasing the second token from the one of the multiple parties, prior to initiating the transfer of the second token to the account of the user.

5. The computer-implemented method of claim 1, wherein the first token is associated with a ledger contract specific to the token host.

6. The computer-implemented method of claim 5, wherein the one or more criteria is based on a percentage of tokens associated with each of the multiple parties.

7. The computer-implemented method of claim 1, wherein the one or more criteria relate to an order of minting the first token relative to the second token.

8. The computer-implemented method of claim 1, wherein initiating the transfer of the second token to the account of the first user includes initiating the transfer, via a payment processing network.

9. A computer-implemented method for use in token management, the method comprising:
receiving, from a first user, a request to redeem a first token having a first value, the first token issued by a consortium of multiple parties;
in response to the request, identifying, by a computing device of a token host, based on one or more criteria, one of the multiple parties to settle a redemption of the first token;
converting the first token to a second token, the second token minted by the one of the multiple parties; and
directing, by the computing device, the one of the multiple parties to transfer funds, which are equivalent to the first value, to an account specific to the first user.

10. The computer-implemented method of claim 9, wherein directing the one of the multiple parties to transfer funds includes directing the one of the multiple parties to include a debit entry in a clearing file for the first value and directing a second one of the multiple parties, which issued the account, to include a credit entry in the clearing file for the first value.

11. The computer-implemented method of claim 9, wherein the first token includes multiple tokens; and
wherein the second token includes multiple tokens.

12. The computer-implemented method of claim 9, wherein directing the one of the multiple parties to transfer the funds includes directing the one of the multiple parties to transfer the funds, via a payment processing network.

13. A computer implemented method for use in token management, the method comprising:
in response to a request to redeem a number of common tokens, for a user:
burning, by a computing device of a token host, the number of common tokens on a ledger, as indicated in a first entry at the ledger; and
transferring, by the computing device, a number of first tokens, which is equal to the number of common tokens, to the user, as indicated at a second entry at the ledger, the first tokens being minted, at the ledger, by a party, which issued an account of the user.

14. The computer-implemented method of claim 13, wherein the number of common tokens is issued by a consortium of multiple parties, the multiple parties including said party, which issued the account of the user.

15. The computer-implemented method of claim 13, further comprising:
purchasing at least a portion of the number of first tokens from the first party, based on an account issued to the token host at the first party, as indicated in a third entry at the ledger; and
wherein transferring the number of first tokens includes transferring the number of first tokens, after receipt of the at least a portion of the number of first tokens from the first party.
